(19) United States
(12) Patent Application Publication
(10) Pub. No.: US 2001/0035962 A1
(43) Pub. Date: Nov. 1, 2001

(54) Method and device for formatting instrumentation output

(76) Inventor: John C. Yundt-Pacheco, Fairview, TX (US)

Correspondence Address: J. David Wharton, SHOOK, HARDY & BACON L.L.P., 1200 Main Street, Kansas City, MO, 64105-2118, US

(21) Appl. No.: 09/800,113

(22) Filed: Mar. 6, 2001

Related U.S. Application Data
(60) Provisional application No. 60/187,113, filed on Mar. 6, 2000.

(51) Int. Cl. G06F 13/12

(52) U.S. Cl. 358/1.1; 358/1.16; 710/65; 710/72

(57) ABSTRACT

A method and device for formatting instrumentation data for collection by an external monitoring facility. A laboratory information system (LIS) computing device receives laboratory instrument output from one or more laboratory instruments. The LIS transfers the data to the operating system for printing. In a first embodiment, a modified printer driver receives the data from the operating system. The driver formats the data according to a standardized format utilizing one or more data store lookups. The formatted data is stored in a file for extraction by the monitoring facility. In a second embodiment, the operating system sends the data to a standard printer driver which formats the data for printing and transfers the data to a modified port monitor. Similar to the modified printer driver, the modified port monitor formats the data utilizing one or more data store lookups and stores the result in a formatted file for extraction by the external monitoring facility. The present invention allows an LIS to format laboratory instrument data for collection without requiring modification to the LIS or the operating system.

### CROSS REFERENCED TO RELATED APPLICATIONS

The present application claims priority of Provisional Application No. 60/187,113filed Mar. 6, 2000.

### STATEMENT REGARDING FEDERALLY SPONSORED RESEARCH OR DEVELOPMENT

Not applicable.

### TECHNICAL FIELD

In general, the present invention relates to laboratory instrument data, and in particularly, to a method and device for formatting laboratory data output from a plurality of laboratory information systems.

### BACKGROUND OF THE INVENTION

Data outputs from an individual laboratory instrument testing a subject sample may be utilized to monitor the performance of the instrument or to provide patient sample data for the subject being tested. For example, one of the operational needs of a clinical laboratory is to constantly monitor the performance of the clinical instrumentation. Typically, this accomplished by having the individual instruments test external quality control specimens, transmitting the results of the tests to an external monitoring facility and verifying that the results are within an expected range. This is commonly referred to as Peer-Group analysis.

Individual laboratory instrument test results are outputted to one or more external laboratory instrument monitoring facilities which accept the laboratory instrument results and perform various analysis on the data, such as the Peer-Group analysis. One conventional method of receiving the laboratory instrument outputs entails the monitoring facilities obtaining the individual instrument output data as printed reports and manually re-entering the data in an electronic format appropriate for the particular monitoring facility. As would be readily understood, the conventional manual data input method is inefficient and costly in terms of additional required labor and also prone to operator error in re-entering the data from the printed report.

Generally, individual laboratory instrument data is collected in an electronic format. Thus, one approach is to have the individual laboratory instruments output the collected data directly to the monitoring facility. However, laboratory instruments are not typically configured to output data directly to an external collection source and incorporating such a functionality may become financially burdensome. Additionally, multiple laboratory instruments often test the same specimen, and it would be advantageous to have all the laboratory instrument output data from testing a specific specimen be transmitted to the monitoring facility at one time.

To facilitate centralized data collections, clinical laboratories have incorporated a central computer system interfaced with, and receiving outputs from, the individual laboratory instruments. The computer system is commonly referred to as a laboratory information system (LIS). Typically, the configuration of each LIS depends on the individual needs of the laboratory, the computing system implementing the LIS functions, and the input needs of the monitoring facility. Nevertheless, although an LIS facilitates the electronic collection of the laboratory instrument data, the transfer of the data to the external laboratory monitoring system is conventionally accomplished by sending the facility one or more printed reports unless the computer system implementing the LIS is modified to contain a specific interface for formatting and transferring the instrument data to the monitoring facility. Thus, even clinical laboratories implementing a LIS system are deficient in the methods of transferring instrument data electronically to one or more external sources.

Based on the above-described deficiencies with data collection, there is a need for a laboratory instrument data formatting method which facilitates electronic data transfers.

### SUMMARY OF THE INVENTION

The present invention satisfies the above-described need by providing a method and device for electronically formatting laboratory instrument outputs.

Generally described, the present invention provides a method for formatting data from a group of laboratory instruments. In accordance with the method, a computer system having a laboratory information system application program, an operating system and a printer driver is utilized. Data indicative of outputs of the group of laboratory instruments is obtained by the laboratory information system application program. The data is transferred by the laboratory information system application program to an operating system for printing. The operating system transfers the data to the printer driver. The printer driver formats the data into a format required by an external monitoring facility. Additionally, the formatted data is stored in a file for extraction by the external monitoring facility.

In another aspect of the present invention, a method for formatting data from a group of laboratory instruments is provided. In accordance with the method, a computer system having a laboratory information system application program, an operating system, a printer driver and a port monitor is utilized. Data indicative of outputs of the group of laboratory instruments is obtained by the laboratory information system application program. The data is transferred by the laboratory information system application program to an operating system for printing. The operating system transfers the data to the printer driver. The printer driver transfers the data to a port monitor. The port monitor formats the data into a format required by an external monitoring facility. Additionally, the formatted data is stored in a file for extraction by the external monitoring facility.

In a further aspect of the present invention, a system for formatting laboratory instrument output data is provided. The system includes a laboratory information system application program for receiving data outputs from one or more laboratory instruments, an operating system operable to run the laboratory information system application program and to provide centralized printing, and a printer driver for receiving data to be printed and formatting the data according to a predetermined format.

In yet another aspect of the present invention, a system for formatting laboratory instrument output data is provided. The system includes a laboratory information system application program for receiving data outputs from one or more laboratory instruments, an operating system operable to run the laboratory information system application program and to provide centralized printing, and a port monitor for receiving data to be printed and formatting the data according to a predetermined format.

### BRIEF DESCRIPTION OF THE DRAWING

The present invention is described in detail below with reference to the attached drawing figures, wherein:

FIG. 1 is a block diagram illustrating the interaction between one or more groups of laboratory instruments and a monitoring server in accordance with the teachings of the present invention;

FIG. 2 is a block diagram illustrating a centralized printing function between a program application, an operating system and a printer;

FIG. 3 is a block diagram illustrating a preferred embodiment of the data collection method of the present invention utilizing a modified printer driver;

FIG. 4 is a block diagram illustrating a preferred format for a printout from a laboratory information system of collected laboratory instrument data;

FIG. 5 is a sample of a printout from a laboratory information system in accordance with the format of FIG. 4;

FIG. 6 is a block diagram illustrating a preferred format for a formatted file from a laboratory information system in accordance with the present invention;

FIG. 7 is a sample of a formatted file in accordance with the format of FIG. 6;

FIG. 8 is a block diagram illustrating the formatting of laboratory instrument data utilizing a data store lookup in accordance with the present invention;

FIG. 9 is a block diagram illustrating a centralized printing function between a program application, an operating system, a port monitor and a printer; and

FIG. 10 is a block diagram illustrating a preferred embodiment of the data collection method of the present invention utilizing a modified port monitor.

### DETAILED DESCRIPTION OF THE INVENTION

The present invention provides a method and device for electronically formatting laboratory instrument outputs for extraction by one or more external monitoring facilities. Preferably, the present invention is implemented in a computing environment commensurate with the number of laboratory instruments in the system and the quantity of data being normalized. The invention is operable with numerous general purpose or special purpose computing system environments. Examples of well known computing systems that may be suitable for use with the invention include personal computers, server computers, hand-held or lap top devices, multiprocessor systems, network personal computers, minicomputers, and mainframe computers. As would be readily understood by someone skilled in the art, additional computing environments are within the scope of the present invention.

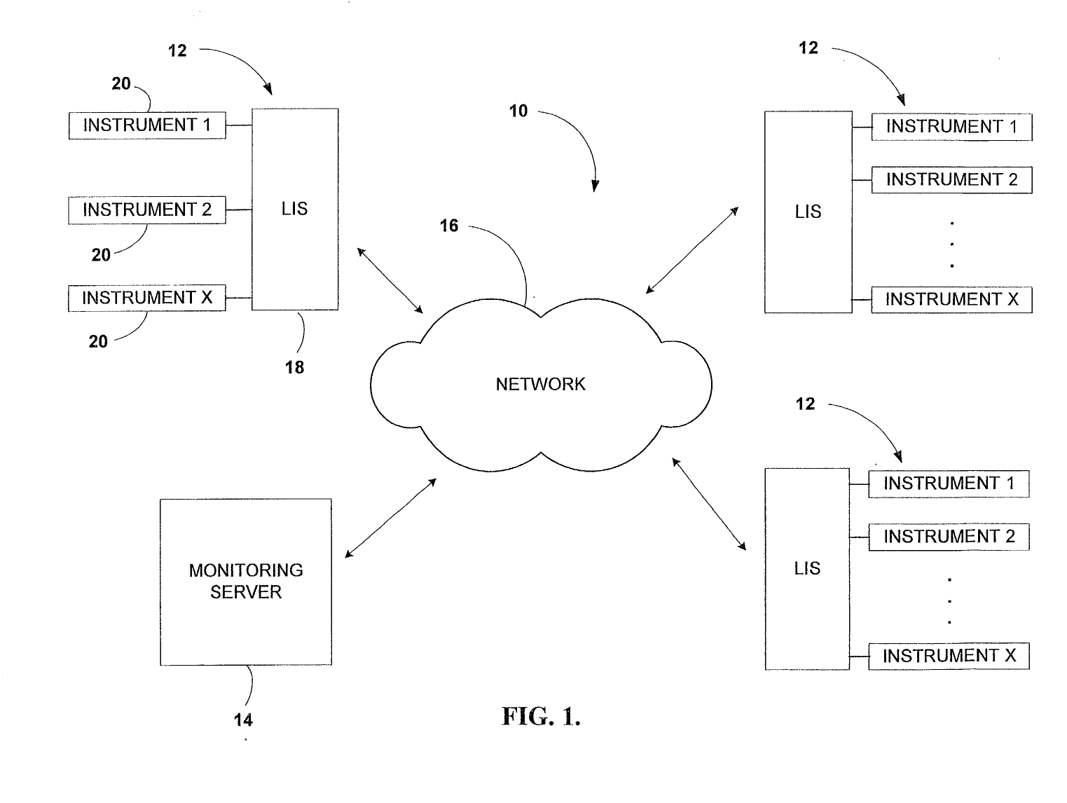

FIG. 1 is a block diagram illustrative of the monitoring system of the present invention, designated generally by the reference number 10. The monitoring system 10 includes one or more laboratory instrument groups 12 in communication with a monitoring server 14 via a communications network 16.

Preferably, each laboratory instrument group 12 includes a laboratory information system (LIS) 18, which is direct communication with one or more laboratory instruments 20. As would be readily understood, the laboratory instrument groups 12 may be remote from each other and from the monitoring server 14. Additionally, the laboratory instruments 20 connected to the LIS 18 may also be remote from each other and from the LIS 18. Moreover, the laboratory instruments 20 may include identical instruments from the same manufacturer, different instruments from the same manufacturer, or instruments from a variety of manufacturers. Preferably, the monitoring server 14 includes one or more computing devices to carry out the functions of the monitoring server 14 in accordance with the present invention.

Preferably, the network 16 includes an Internet-based network, with the monitoring server 14 linked to the groups of laboratory instruments via a web site interface. As would be understood, the network can include any variety and/or combination of Local Area Networks (LAN) or Wide Area Networks (WAN) to facilitate communication between the laboratory groups and the normalization server. Additionally, the network 16 may include a dedicated communications link, such as dial-up telephone modem connection, between the groups of laboratory instruments 12 and the monitoring server 14.

The present invention relates to a method and device which allows both a laboratory information system (LIS) program application and an operating system to generate formatted data for extraction by an external monitoring system, such as monitoring server 14, without any need to modify the LIS program or the operating system. Instead, when implemented in a computing environment having centralized printing functions, the present invention intercepts standard printing function data communications, formats the laboratory instrument data included in the communication and stores the formatted data in a file for transfer to the external laboratory monitoring facility.

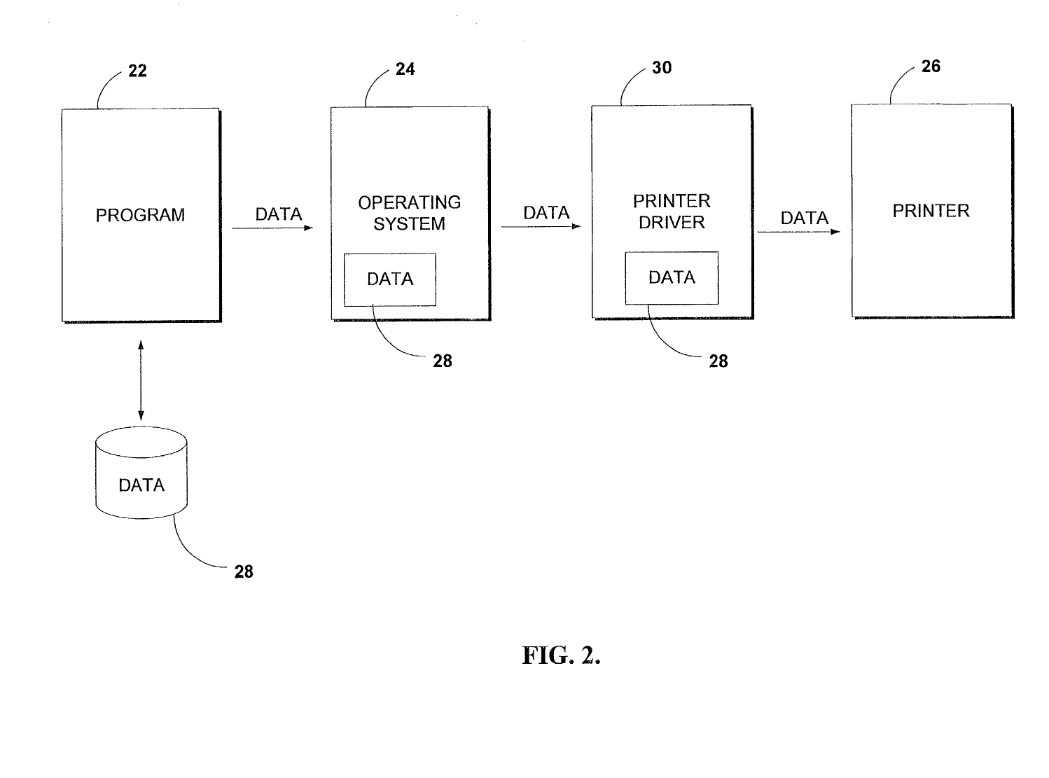

FIG. 2 is a block diagram illustrating a centralized printing function between a application program 22, an operating system 24 and a printer 26 illustrating an operating system having device independent printing subsystem. One system that implements such a centralized printing function is Microsoft Corporation's “WINDOWS®” brand operating system. Although the present application will be described preferably in the context of the WINDOWS operating system, alternative operating environments having similar properties are considered within the scope of the present invention.

Specifically, FIG. 2 illustrates a conventional method of communicating printer data from the application program 22 to the printer 26. An application program 22 contains data 28 that is desired to be transferred to the printer 26. Because the computing environment in which the application program 22 is connected may have a variety of devices which can receive outputs from the program, the application program 22 does not directly contain the appropriate instructions to cause the output device, in this case a printer 26, to output the data 28. Instead, the application program 22 transfers the data to the operating system 24 via the standard communication means of the computing environment. After receiving the data 28, the operating system 24 stores the data 28 for transferring to the printer driver. For example, the operating system 24 may have a graphics device interface (GDI) which accepts data and transfers it to one or more devices.

In a first embodiment, the operating system 24 stores the data, such as in a printer spooler (not shown), for a delay in sending it to the printer driver 30. In a second embodiment, the operating system 24 sends the data 28 directly to the printer driver 30. Regardless of which embodiment is utilized, once the printer driver 30 receives the data 28, it processes the data into a format appropriate to be received by the printer 26 by adding appropriate printer headers or other parsing functions. The formatted data 28 is transferred to the printer 26, which generates the printout. Thus, the application program 22 and the operating system 24 send the data in a generic format for printing and the printer driver 30 functions to modify the data or insert the commands necessary to allow the device, such as the printer, to generate the appropriate output. Accordingly, if a new device is added to the computing environment, no modifications are required to allow the application program to utilize the new device other than loading a new or modified device driver to be utilized by the operating system 24.

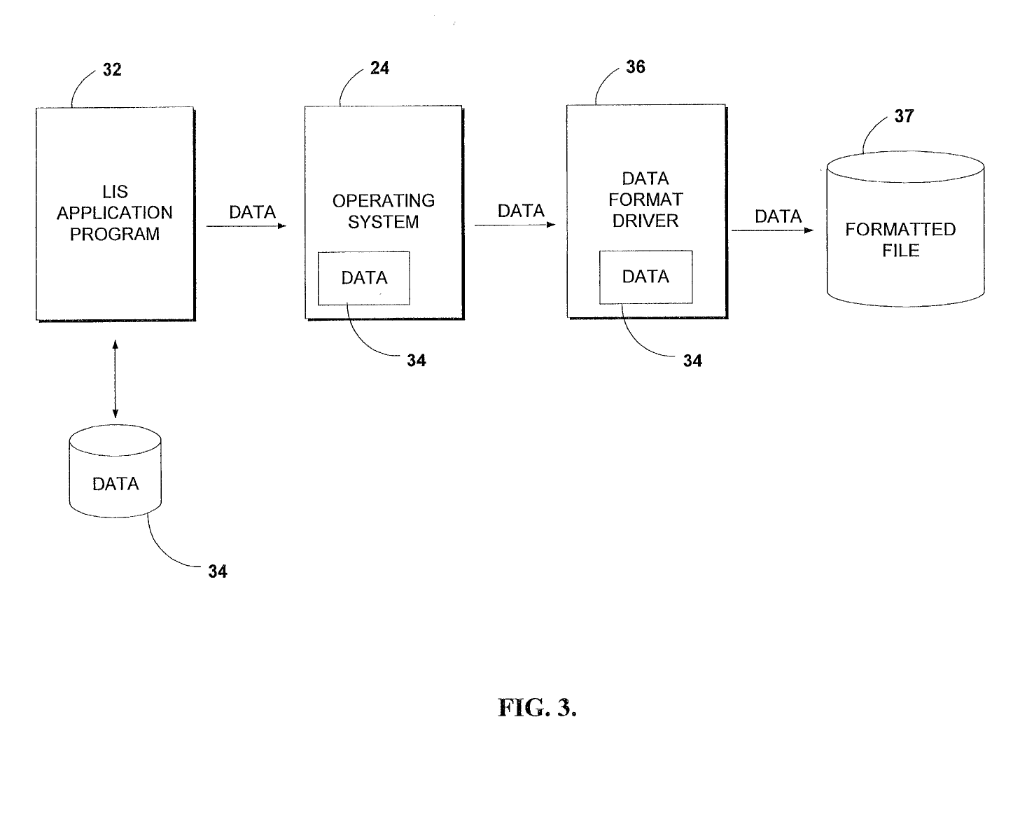

FIG. 3 is block diagram illustrating a preferred embodiment of the present invention in which a modified device driver is utilized to format laboratory instrument data. In this embodiment, a LIS application program 32 receives laboratory instrument data 34 from one or more laboratory instruments (FIG. 1) for formatting and transfer to an external monitoring system (FIG. 1). Once the data 34 is collected, the LIS application program 32 transfers the collected data 34 to the operating system 24. Typically, the data 34 can be stored by the LIS software application program until the collection is completed, or it may be directly transferred to the operating system 24 for immediate formatting. At this point, the LIS software application program 32 is not required to format the data 34 in any way for export to the external monitoring facility. Similar to the discussion with regard to FIG. 2, after the data 34 is received by the operating system 24, the data 34 may be temporarily stored for immediate transfer to a device driver 36, or it may be stored in spooler (not shown) for later transfer.

Once the data 34 is ready to be transferred to the device driver 36, the operating system 24 transfers the data 34 over any variety of standard communication means of the computing environment. Thus, to the operating system 24, the data 34 is being sent as if it was going to a device connected to the computer system, such as a printer or a monitor. The data 34 is received by printer driver 34 where it is formatted in a manner required by the external monitoring facility.

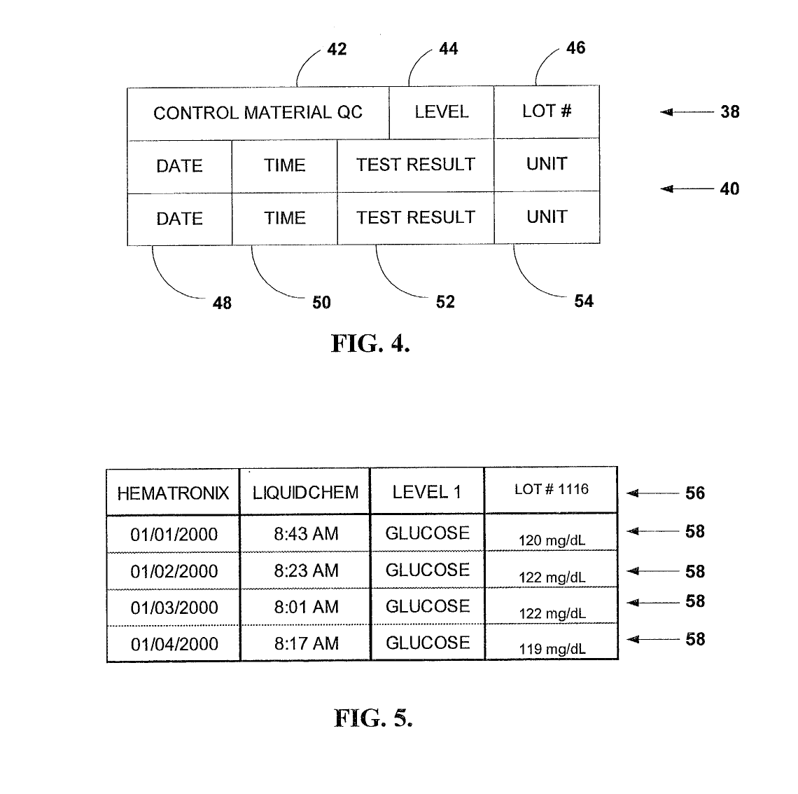

FIGS. 4 and 5 illustrate a sample format in which instrument data is generated for printing by a LIS application program. With reference to FIG. 4, the typical format includes a title portion 38 and a data portion 40. Preferably, the title portion 40 includes a field for the title of the external quality control material 42, a field for the level of the material 44 and lot number for the material 46. Additionally, the data portion 40 contains one or more rows of data which preferably include a date field 48, a time field 50, a test result field 52 and a unit field 54. As would be readily understood by someone skilled in the relevant art, modified, additional, or different field formats would be applicable to the present invention and are considered within the scope of the present invention. FIG. 5 illustrates sample data formatted in accordance with the field layout of FIG. 4. The sample printed sheet includes a title field 56 and four rows of data fields 58.

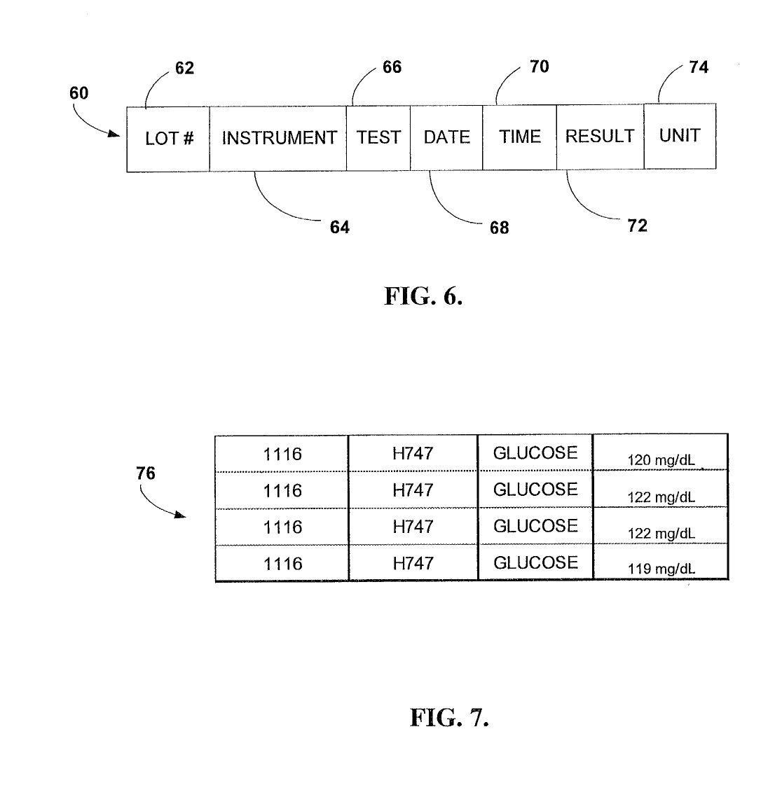

In contrast, FIGS. 6 and 7 illustrated a standardized format in which the instrument data needs to be collected by the external monitoring facility. With reference to FIG. 6, the typical format 60 includes a lot number field 62, an instrument identification field 64, a test type identification field 66, a test date field 68, a test time field 70, a substance amount field 72 and a measured units field 74. As would be readily understood, the number, type and organization of the format 60 will vary according to the testing facility and the sample being tested. All such modifications are within the scope of the present invention. FIG. 7 illustrates the sample data from FIG. 5 regenerated according to the format 60 (FIG. 6). The data 76 is now formatted as four rows.

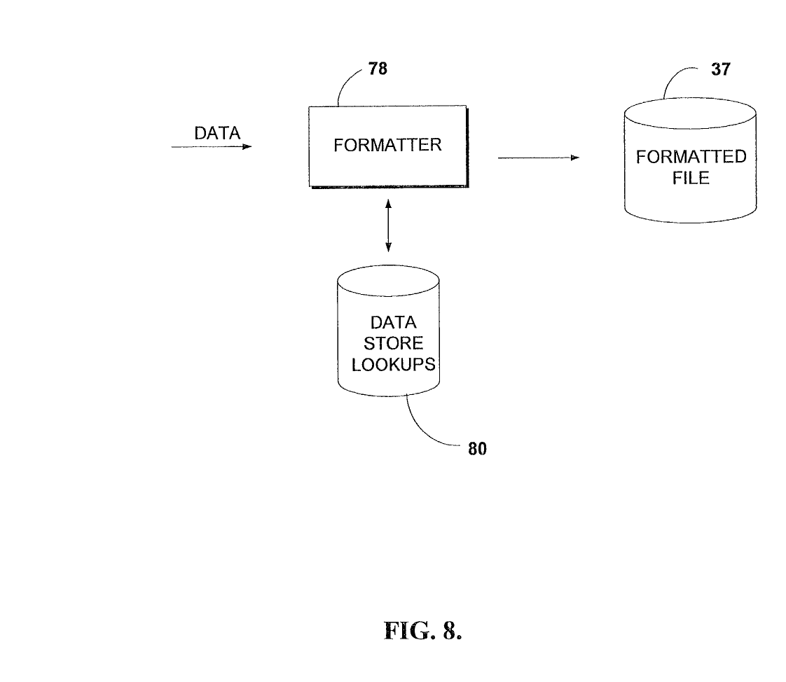

FIG. 8 is a block diagram illustrating how a data formatter 78, such as the modified printer driver 34 (FIG. 3), utilizes one or more data store lookups 80 to convert raw collected data as illustrated in FIG. 5 to formatted data as illustrated in FIG. 7. Because portions of the data collected from the raw data would not be in a suitable form for sending to the external monitoring facility, the data store lookups 80 can be utilized to find appropriate codes or additional information to allow for a proper format. For example, in FIG. 5, the printed report includes “GLUCOSE” in the test field 52. However, in this example, the appropriate code for the monitoring facility would be “GLU”. Accordingly, the data store lookups 80 convert the raw data accordingly. Likewise, with reference to the format 60 of FIG. 6, the formatted data must indicate in field 64 the laboratory instrument from which the data originated. Thus, once the laboratory instrument is identified, either in the printed data generated by the LIS or by the operating system in a separate communication, the data store lookups 80 insert the specific identification code of the laboratory instrument into the identification field. With reference to FIGS. 7 and 8, in this example, the data store lookups 80 provide that the code for the particular laboratory instrument outputting the data is “H747.” Thus, the formatter 78 scans the raw data for the required fields, utilizes the data store lookup 80 to convert the data into appropriate codes, and then organizes the raw data into the appropriate order.

With reference again to FIG. 3, once the data format driver 36 receives and formats the data 34, the data 34 is stored as a formatted file 37 in the computing environment. Accordingly, the computing system could contact the external monitoring facility to communicate that a formatted file is available or the file may be stored in a memory until the external monitoring facility requests the data. To the user of the LIS, however, the data is considered transferred from the moment it is “printed” to the file. Moreover, the present invention may be utilized in conjunction with a standard printing function such that when a user prints the report, the formatted file is automatically created as well. Thus, the user would not have to do any additional steps to generate the formatted file.

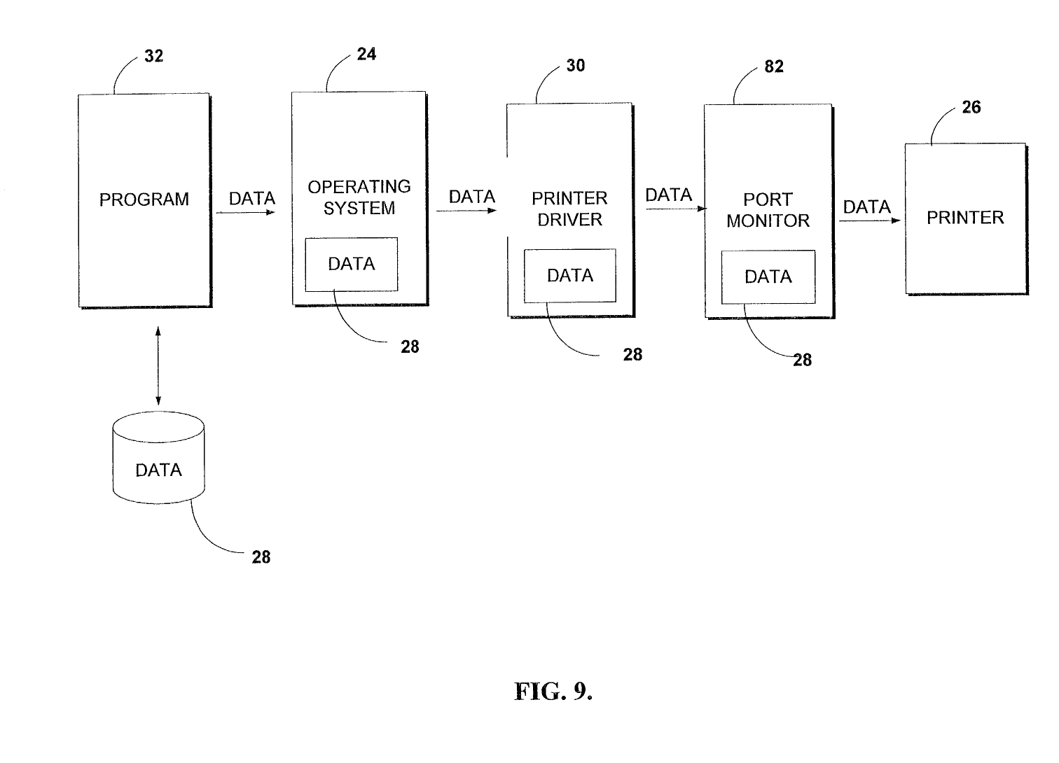

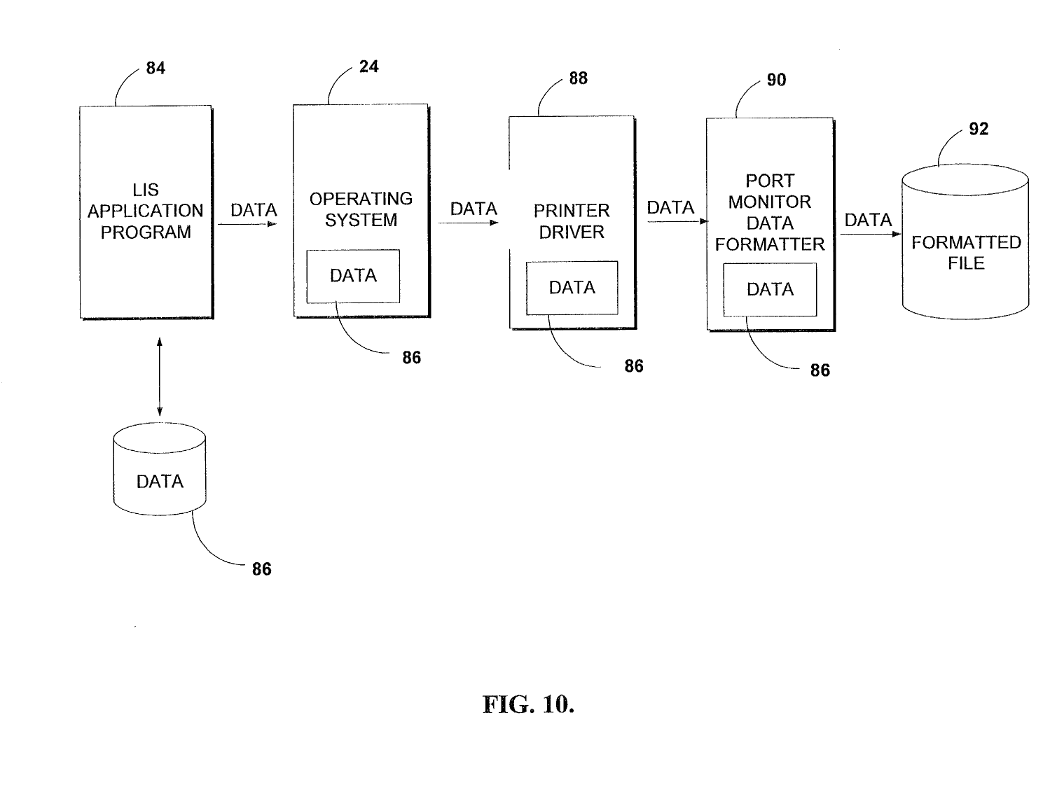

FIGS. 9 and 10 are block diagrams illustrating a second embodiment in which laboratory instrument data may be formatted to file utilizing a centralize printing operating environment. Similar to FIG. 2, FIG. 9 illustrates a conventional printing function in which an application program 22 sends data 28 to a printer 26 via the operating system 24. The operating system 24 receives the data 28 and transfers it to a printer driver 30. The printer driver 30 then transfers the data 28 to a port monitor 82. The port monitor 82 is a system which typically manipulates printer data 28 to direct it to the connection port of the computer system in which the printer 26 is connected. Placing the data 28 at the appropriate port, the printer 26 prints the data 28.

FIG. 10 illustrates an embodiment of the present invention in which a port monitor 90 is modified to intercept laboratory instrument data 86 for formatting to a file 92. Similar to FIG. 3, an LIS application program 84 collects output data 86 from one or more laboratory instruments (FIG. 1). The data 86 is transmitted to the operating system 24 via standard communications means of the computing system. Again, the operating system may temporarily store the data 86 for immediate transfer, or may spool the data 86 for delayed transfer.

The operating system 24 then transfers the data 86 to a printer driver 88, which corresponds to at least one of the devices connected to the computing system. As would be readily understood, the device driver may also be a driver for any of the plurality of the devices that can be connected to the computing system. Because the driver 88 is preferably a generic printer driver, the data 86 is formatted for printing and transferred to the port monitor 90 for direction to the proper computer port.

Upon receiving the data 86, the port monitor 90 servers as the data formatter 78 (FIG. 8) for the data 86. With reference to FIGS. 5-8, the data 86 is received in a format ready for printing. Accordingly, the port monitor 90 receives the printer-formatted data and utilizes the data store lookups 80 to generate a formatted file 92 as illustrated in FIG. 7. Additionally, the port monitor may also send the printer data directly to a printer 26 (FIG. 9) for concurrent formatting and printing. Again, the computing system may contact the external monitoring facility each time a formatted file is created or the formatted file may be stored for eventual collection.

Although the second embodiment utilizes a similar data formatting technique, the formatting takes place on the port monitor level as opposed to the printer driver level. In some situations, the second embodiment may be preferable if the software requirements of creating an modified device driver may higher than to create a modified port monitor.

An alternative embodiment could utilize a combination of the modified printer driver of the first embodiment and the modified port monitor of the second embodiment at the same time. In this embodiment, the user may designate which device, either the printer driver or the port monitor, should modify the data, or both devices may modify the data in different formats.

The present invention facilitates the use of a standardize central printing environment to format data without requiring any modifications to the LIS application program or the operating system. By creating software drivers and/or port monitors which intercept, format and store the formatted data, the user can create formatted files without requiring additional data entry or many additional conversions steps. Additionally, if the external monitoring facility modifies the format for collection or if a different external monitoring facility is used, the only modification required to continue producing formatted files would be to interchange the printer driver/port monitor with one compatible with the new format. From the user perspective, however, there would be no additional modifications to the system or to the use of the system.

It will be understood that certain features and subcombinations are of utility and may be employed without reference to other features and subcombinations.

Since many possible embodiments may be made of the invention without departing from the scope thereof, it is to be understood that all matter herein set forth or shown in the accompanying drawings is to be interpreted as illustrative, and not in a limiting sense.

We claim:

1. In a computer system having a laboratory information system application program, an operating system and a printer driver, a method for formatting data from a group of laboratory instruments, the method comprising:
obtaining data indicative of outputs of the group of laboratory instruments by the laboratory information system application program;
transferring the data, by the laboratory information system application program, to an operating system for printing;
transferring the data, by the operating system, to the printer driver;
formatting of the data, by the printer driver, into a format required by an external monitoring facility; and
storing the formatted data in a file for extraction by the external monitoring facility.

2. In a computer system having a laboratory information system application program, an operating system, a printer driver and a port monitor, a method for formatting data from a group of laboratory instruments, the method comprising:
obtaining data indicative of outputs of the group of laboratory instruments by the laboratory information system application program;
transferring the data, by the laboratory information system application program, to an operating system for printing;
transferring the data, by the operating system, to the printer driver;
transferring the data, by the printer driver, to the port monitor;
formatting of the data, by the port monitor, into a format required by an external monitoring facility; and
storing the formatted data in a file for extraction by the external monitoring facility.

3. A system for formatting laboratory instrument output data, the system comprising:
a laboratory information system application program for receiving data outputs from one or more laboratory instruments;
an operating system operable to run the laboratory information system application program and to provide centralized printing; and
a printer driver for receiving data to be printed and formatting the data according to a predetermined format.

4. A system for formatting laboratory instrument output data, the system comprising:
a laboratory information system application program for receiving data outputs from one or more laboratory instruments;
an operating system operable to run the laboratory information system application program and to provide centralized printing; and
a port monitor for receiving data to be printed and formatting the data according to a predetermined format.
